(19) United States
(12) Patent Application Publication
(10) Pub. No.: US 2020/0180300 A1
(43) Pub. Date: Jun. 11, 2020

(54) MESHLESS FOIL STENCIL FRAME

(71) Applicant: Ricky Paul Bennett, Flemington, NJ (US)

(72) Inventor: Ricky Paul Bennett, Flemington, NJ (US)

(21) Appl. No.: 16/046,714

(22) Filed: Jul. 26, 2018

(51) Int. Cl. B41F 15/34

(52) U.S. Cl. CPC B41F 15/34; B41P 2200/40; B41P 2219/22

(57) ABSTRACT

A meshless foil stencil frame removes all the components of mesh mounted frames and associated issues and mechanically attaches the foil to an aluminum frame by way of pre-cut tabs. Tension is applied by either pulling on all four sides of the frame and then placing a spacer at each corner to maintain the displacement of each frame member or locking the corners and placing a displacement insert between frame and foil. This displacement in turn applies pressure on a foil which is held firm at each of the four edges and therefore creates tension on the foil.

### BACKGROUND OF THE INVENTION

The present invention relates to stencil apparatus and, more particularly, to a stencil frame that can retain and tension a stencil without requiring a conventional polyester mesh.

Traditionally, stencils used for depositing solder paste are composed of a metal foil that is attached, suspended and tensioned by a polyester mesh to an aluminum frame. Although the mesh mounted surface mount technology (SMT) stencil has been in production for many years, the printing process has been growing more complex and therefore requires a high degree of consistency, accuracy and reliability from frame to frame.

Referring to FIG. 1A, a polyester mesh 100 is stretched to a known tension then glued with an adhesive 102 to a frame 104. This is then allowed to cure and the excessive mesh is cut off. In FIG. 1B, a stainless steel foil 106 is laid on to the mesh 100 and an adhesive 108 is applied between the outer perimeter of the foil and the mesh and allowed to cure. In FIG. 1C, the frame is flipped over and the mesh is cut away to expose the steel foil 106. Additional adhesive 110 is applied on to the mesh 100 around the foil 106 to secure the mesh 100 and cover exposed mesh edge.

Associated issues with the conventional method using a polyester mesh. Key components that affect the accuracy, coplanarity and consistency of a mesh mounted foil are (1) Variation of tension of the mesh mounted process. (2) Variation of the thickness of adhesive used for mounting of the mesh. (3) Variation of thickness of adhesive used for mounting the foil on to the mesh. (4) Positioning of foil onto the mesh. (5) Foil may move (pattern float) during the printing process due to mesh stretch. (6) De-lamination of foil or mesh from extended use and harsh cleaning chemicals and cleaning process. (7) Lengthy manufacturing process which includes many steps, specialized equipment, materials. (8) Demand for lower cost stencils, improved margins. (8) Reduced useable printing area due to mesh and adhesive for foil mounting. (Common frame types, 29″×29″ OD with 26″×26″ ID and 23″×23″ OD with 20″×20″ ID). (9) Stencil printer Underside Wiping systems affected by adhesive on foil mounting.

As can be seen, there is a need for a method and apparatus for tensioning a foil in a frame without the need for a polyester mesh.

### SUMMARY OF THE INVENTION

Embodiments of the present invention provide a stencil system comprising a plurality of frame members configured to retain an outer periphery of a foil; corners formed by adjacent ones of the plurality of frame members being floating and not fixed to each other; and a spacer inserted one or more of the corners, separating the corners and providing tension to the foil.

Embodiments of the present invention further provide a stencil system comprising a plurality of frame members configured to retain an outer periphery of a foil; corners formed by adjacent ones of the plurality of frame members fixed to each other; and a displacement spacer inserted along at least a portion of the foil where the foil exits the plurality of frame members, thereby providing tension to the foil.

Embodiments of the present invention also provide a method for tensioning a foil in a frame comprising inserting tabs formed about a periphery of a foil into a plurality of frame members to retain an outer periphery of the foil therein; maintaining corners formed by adjacent ones of the plurality of frame members in a floating and not fixed configuration prior to tensioning the foil; and inserting a spacer into one or more of the corners, separating the corners and providing tension to the foil.

These and other features, aspects and advantages of the present invention will become better understood with reference to the following drawings, description and claims.

### BRIEF DESCRIPTION OF THE DRAWINGS

FIGS. 1A through 1C show views illustrating the assembly of a conventional foil on a frame with a polyester mesh;

FIG. 2A shows tabs cut into the foil adjacent an outer periphery thereof according to an exemplary embodiment of the present invention;

FIG. 2B shows a top view of the tabs of the foil of FIG. 2A disposed in a profiled frame extrusion;

FIG. 2C shows a top perspective view of the foil and frame of FIG. 2B;

FIG. 2D shows cross-sectional view showing a foil engaged into a frame;

FIG. 3A shows placement of a foil, having a plurality of tabs cut into the foil adjacent an outer periphery thereof, into a profiled frame extrusion, according to an exemplary embodiment of the present invention;

FIG. 3B shows the foil snapped onto the profiled frame;

FIG. 4 shows an exemplary embodiment for tension to be applied to the sides frame members to, in turn, apply tension to the foil attached thereto;

FIG. 5A shows a detail bottom view of a frame having an internal L-shaped corner brace;

FIG. 5B shows how tensioning of the foil by applying a force to the frame separates the corner about the L-shaped corner brace, where a clip may be inserted therein to maintain the desired tension;

FIG. 5C shows a corner member of the frame with the foil attached and the C-clip inserted to maintain a desired separation, and, thus, a desired tension on the foil;

FIG. 6A shows a detail bottom view of a frame having an internal L-shaped corner brace;

FIG. 6B shows how tensioning of the foil by applying a force to the frame separates the corner about the L-shaped corner brace, where a tension/locking spacer may be inserted therein to maintain the desired tension;

FIG. 6C shows a corner member of the frame with the foil attached and the tension/locking spacer inserted to maintain a desired separation, and, thus, a desired tension on the foil;

FIG. 6D shows the tension/locking spacer of FIG. 6B; and

FIG. 6E shows a locking plate that may be used to help support the corner and maintain the tensioned state of the foil;

FIG. 7A shows an alternate method for applying tension on the foil once the tabs are inserted into the frame;

FIG. 7B shows the optional application of an external tensioning frame to apply additional tension to the foil; and

FIG. 8 shows an exemplary arrangement of C-cuts in a foil according to an exemplary embodiment of the present invention.

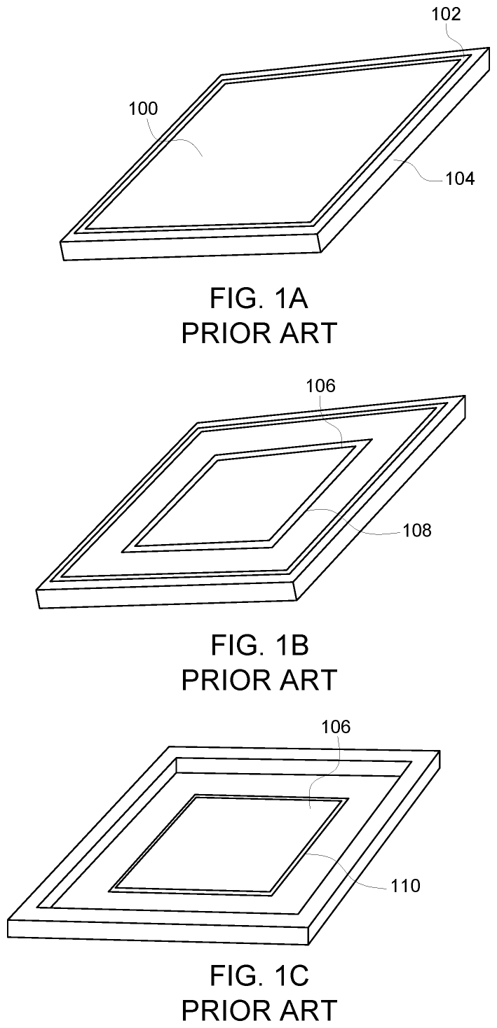

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, an embodiment of the present invention removes all the components of mesh mounted frames and associated issues and mechanically attaches the foil to an aluminum frame by way of pre-cut tabs. Tension is applied by either pulling on all four sides of the frame and then placing a spacer at each corner to maintain the displacement of each frame member or locking the corners and placing a displacement insert between frame and foil. This displacement in turn applies pressure on a foil which is held firm at each of the four edges and therefore creates tension on the foil.

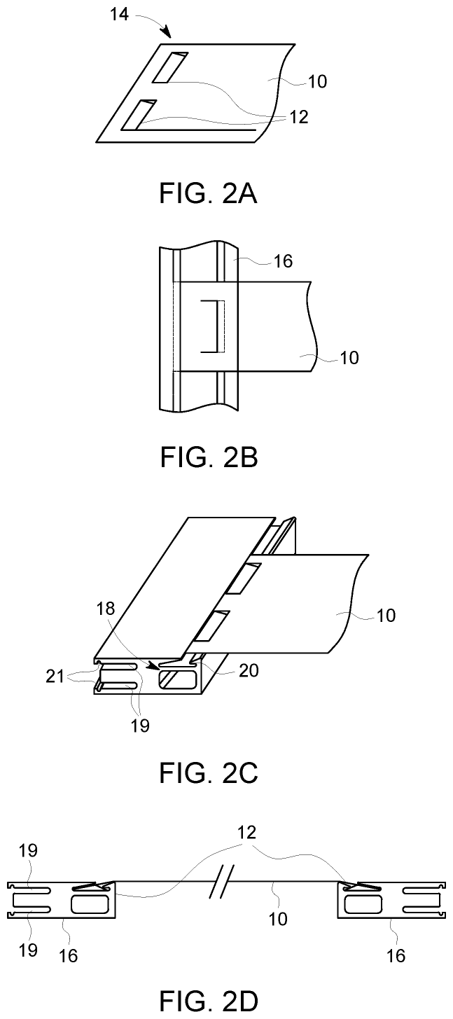

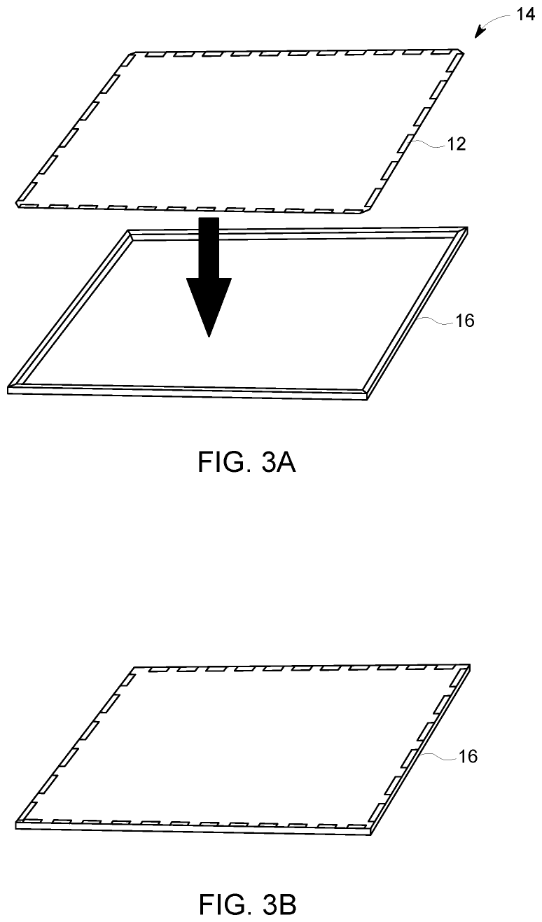

Referring now to FIGS. 2A through 3D, a foil 10 can have a tab 12 cut therein, such as a C-shaped cut tab. The tab 12 can be formed by various methods, such as punching or cutting (with a laser or the like) through and around the perimeter of the foil 10. The pre-cut foil 14 can be placed over a specifically designed extrusion 16 (also referred to as frame 16) so that the tabs 12 can be pressed into a profile 18 and catch onto a protrusion 20 on the frame 16 as best seen in FIGS. 2D and 3D. In some embodiments, the frame 16 can also be slid on to foil 10 if the tabs 12 are pressed down prior to mounting.

In some embodiments, the frame 16 can include an outer profile having slots 19 communicating with an exterior of the frame 16 at an upper and lower position thereof. Channels 21 may be cut along each of the slots 19 near an outer end thereof. The channels 21 may by cut in the upper and lower slots 19 at a similar or the same location, providing a uniform channel 21 in the upper one of the slots 19 and a uniform channel 21 in the lower one of the slots 19. The channels 21 may permit an item to be slid therein, such as a color-coded card so that the frame 16 may be identified along its side by a particular color, for example.

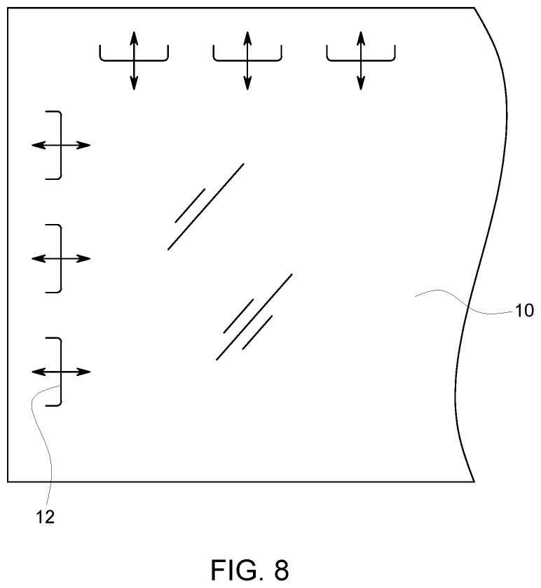

In some embodiments, as shown in FIG. 8, altering the position of the C-Cuts/Tabs 12 can alter the tension across the foil area. If the tabs 12 are all in a straight line, the frame 10 will apply a tension across each side, however, the corners, based upon shorter distance, may have a tension increase dramatically. To compensate and create a more uniform tensioned stencil, moving the tabs 12 further away/back at the corners can reduce tension. In some embodiments, the size and position of the C-cuts/tabs 12 will not only create a locking mechanism to the frame 10 but can be used to customize tension, creating a uniform and balanced stencil.

FIG. 3A shows the pre-cut foil 14 with tabs 12 being placed onto the frame 10. Pressing down on the tabs 12 can bend and snap them down in to the cavity of the extrusion as discussed above. An alternative method is to slide each of the four members of the frame 16 on the edge of the foil 10 one at a time. This method requires tabs 12 to be pressed down from the foil 10 prior to sliding the members of the frame 16. Regardless of installation method, FIG. 3B shows the foil 10 placed onto the profiled frame 16. FIG. 2D shows a cross-section of the assembly of FIG. 3B.

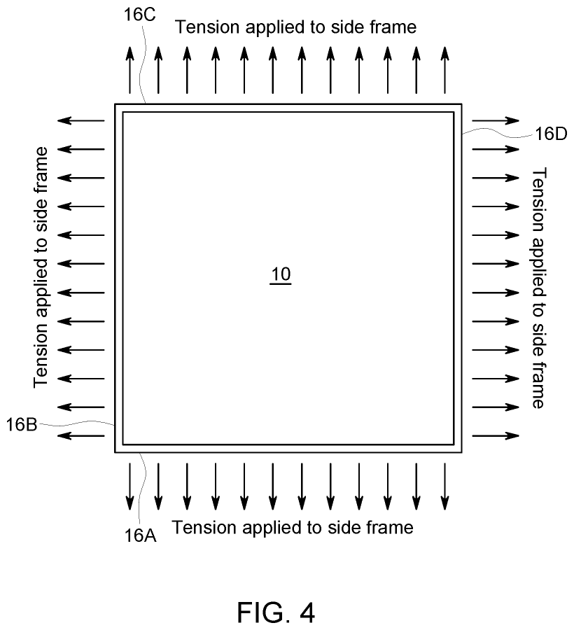

When the foil 10 has been attached as shown in FIG. 3B, it may require further tensioning. FIG. 4 shows an exemplary method of applying outward forces to all four sides of the frame 16, thus applying higher tension across the foil 10. Each frame member can be floating to each other to allow this to happen. In other words, the corners of each of the frame members 16A, 16B, 16C 16D are not fixed to adjacent corners while the foil 10 is tensioned.

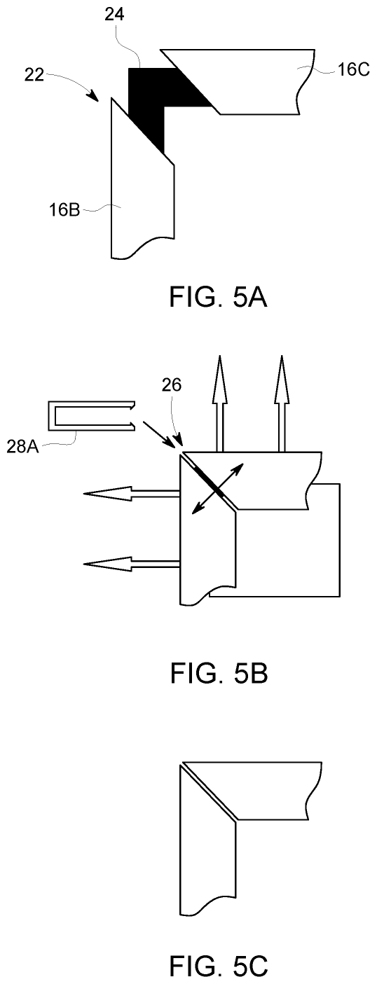

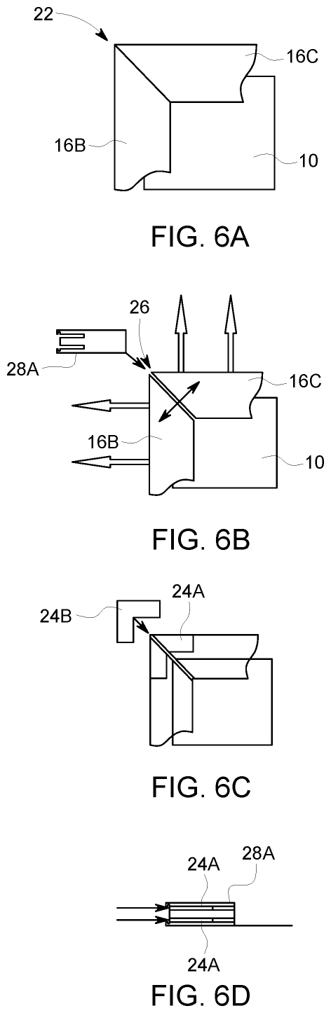

Referring to FIGS. 5A through 5C, each corner 22 formed by adjacent frame members, such as frame members 16B and 16C, can have an internal corner brace 24 inserted to ensure rigidity at each corner 22. With forces pulling on each side of the frame, the corners 22 can pull apart (as shown in FIGS. 5B and 6B), creating a gap 26. Inserting a spacer 28 into this gap 26 can maintain the displacement of the four frame members 16A, 16B, 16C, 16D and therefore retain the tension on the foil 10. The internal corner brace 24 may also have a locking mechanism to ensure corners 22 are rigid to each other.

Referring now to FIGS. 6A through 6E, each corner 22 formed by adjacent frame members, such as frame members 16B and 16C, with forces pulling on each side of the frame, can pull apart (as shown in FIGS. 5B and 6B), creating a gap 26. Inserting a tension/locking spacer 28A into this gap 26 can maintain the displacement of the four frame members 16A, 16B, 16C, 16D and therefore retain the tension on the foil 10. The spacer 28A may have a profile matching the outer profile of the frame 16 (see FIGS. 2C and 2D). An L-shaped corner lock 30 may be disposed on the corner 22, spanning over a portion of frame members 16B, 16C, to lock the tensioned state of the foil 10. In some embodiments, a locking plate 32 may be disposed on the corner, spanning over a portion of frame members 16B, 16C, to lock the tensioned state of the foil 10. In some embodiments, two corner inserts 24A, 24B may be inserted into the slots 19 of the frame (and the corresponding profile of the spacer 28A), allowing the frame to slide along the corner inserts 24A, 24B as the corners of the frame are separated to create tension in the foil.

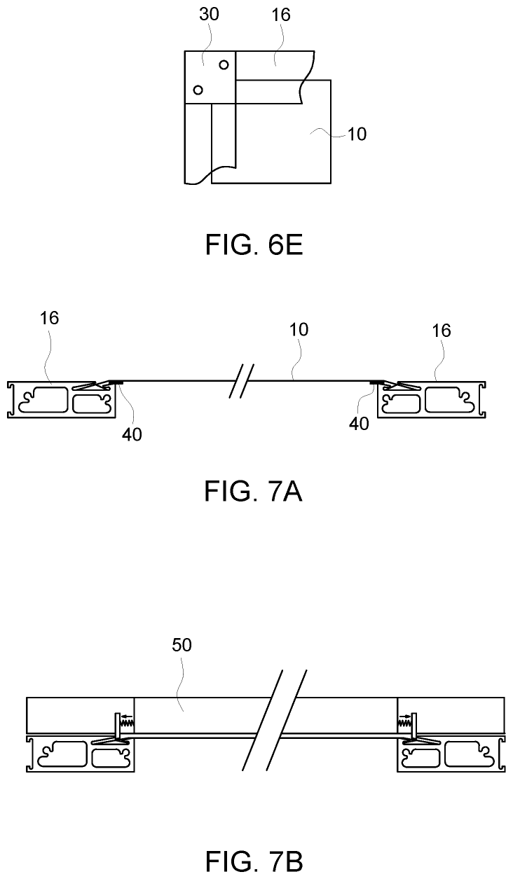

Referring to FIG. 7A, instead of tensioning the foil 10 through pressure being applied on the frame 16 as shown in FIG. 4, an alternative tensioning method uses a displacement insert 40 between the frame 16 and foil 10 with the corners pre-locked together. With the frame locked, sliding different thicknesses of the displacement insert 40 can apply a force that equates to tension on the foil 10. The thickness of the displacement insert 40 may be constant or may vary to ensure even tension across the foil 10.

Referring to FIG. 7B, an external frame 50 could be used to add additional tension to the foil 10. The external frame 50 may be attached to increase tension and may remain attached until printing is complete. The external tensioning frame 50 can be removed and stencil can be stored.

It should be understood, of course, that the foregoing relates to exemplary embodiments of the invention and that modifications may be made without departing from the spirit and scope of the invention as set forth in the following claims.

What is claimed is:

1. A stencil system comprising:
a plurality of frame members configured to retain an outer periphery of a foil;
corners formed by adjacent ones of the plurality of frame members being floating and not fixed to each other; and
a spacer inserted one or more of the corners, separating the corners and providing tension to the foil.

2. The stencil system of claim 1, further comprising a corner brace inserted into adjacent ones of the plurality of frame members at each of the corners.

3. The stencil system of claim 1, further comprising one or more corner locks, the corner locks spanning and attached to adjacent ones of the plurality of frame members at each of the corners.

4. The stencil system of claim 3, wherein the one or more corner locks are L-shaped corner locks.

5. The stencil system of claim 3, wherein the one or more corner locks are locking plates.

6. The stencil system of claim 1, wherein the foil has tabs formed therein for engagement with the plurality of frame members.

7. The stencil system of claim 6, wherein the tabs are disposed along a straight line and at a constant distance from each edge of the foil.

8. The stencil system of claim 6, wherein the tabs are disposed at varying distances from each edge of the foil.

9. The stencil system of claim 1, further comprising an external tensioning frame attached to each of the plurality of frame members to push the plurality of frame members away from each other and apply tension to the foil.

10. A stencil system comprising:
a plurality of frame members configured to retain an outer periphery of a foil;
corners formed by adjacent ones of the plurality of frame members fixed to each other; and
a displacement spacer inserted along at least a portion of the foil where the foil exits the plurality of frame members, thereby providing tension to the foil.

11. The stencil system of claim 10, wherein the foil has tabs formed therein for engagement with the plurality of frame members.

12. The stencil system of claim 11, wherein the tabs are disposed along a straight line and at a constant distance from each edge of the foil.

13. The stencil system of claim 11, wherein the tabs are disposed at varying distances from each edge of the foil.

14. The stencil system of claim 10, further comprising an external tensioning frame attached to each of the plurality of frame members to push the plurality of frame members away from each other and apply tension to the foil.

15. A method for tensioning a foil in a frame, comprising:
inserting tabs formed about a periphery of a foil into a plurality of frame members to retain an outer periphery of the foil therein;
maintaining corners formed by adjacent ones of the plurality of frame members in a floating and not fixed configuration prior to tensioning the foil; and
inserting a spacer into one or more of the corners, separating the corners and providing tension to the foil.

16. The method of claim 15, further comprising inserting a corner brace into adjacent ones of the plurality of frame members at each of the corners.

17. The method of claim 15, further comprising attaching one or more corner locks to adjacent ones of the plurality of frame members at each of the corners.

18. The method of claim 15, wherein the tabs are disposed along a straight line and at a constant distance from each edge of the foil.

19. The method of claim 15, wherein the tabs are disposed at varying distances from each edge of the foil.

20. The method of claim 10, further comprising applying additional tension to the foil with an external tensioning frame attached to each of the plurality of frame members, the external tensioning frame pushing the plurality of frame members away from each other and applying tension to the foil.
